(19) United States
(12) Patent Application Publication
(10) Pub. No.: US 2025/0377183 A1
(43) Pub. Date: Dec. 11, 2025

(54) Instrumented Ammunition Round

(71) Applicants: Michael R. Dipalo, Fredericksburg, VA (US); Hillar C. Lago, Fredericksburg, VA (US)

(72) Inventors: Michael R. Dipalo, Fredericksburg, VA (US); Hillar C. Lago, Fredericksburg, VA (US)

(73) Assignee: United States of America, as represented by the Secretary of the Navy, Arlington, VA (US)

(21) Appl. No.: 18/739,390

(22) Filed: Jun. 11, 2024

(51) Int. Cl. F41A 31/00; F42B 8/08; F42B 12/36; G01K 1/024; G01K 7/02; G01K 13/00

(52) U.S. Cl. CPC F41A 31/00; F42B 8/08; F42B 12/365; G01K 1/024; G01K 13/00; G01K 7/02

(57) ABSTRACT

An inert round is provided for data collection in a gun bore. The round includes a hollow annular cartridge, an instrument package, a circular dielectric disk, an annular projectile and a conical nose tip. The cartridge defines an interior volume longitudinally bounded by a fore neck and an aft terminus. The instrument package is disposed into the volume for data transmission. The circular dielectric disk secured at the aft terminus. The projectile includes an ogive forebody and a cylindrical aftbody that inserts into the neck. The nose tip attaches into the forebody.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to instrumented ammunition. In particular, the invention relates to an inert ammunition round equipped with instruments to measure and transmit temperature within a gun chamber.

### SUMMARY

Conventional measurement techniques within a gun barrel yield disadvantages addressed by various exemplary embodiments of the present invention. In particular, various exemplary embodiments provide an inert round for data collection in a gun bore. The round includes a hollow annular cartridge, an instrument package, a circular rim dielectric disk, an annular projectile and a conical nose tip. The cartridge defines an interior volume longitudinally bounded by a fore neck and an aft terminus. The instrument package is disposed into the volume for data transmission. The circular dielectric disk secured at the aft terminus. The projectile includes an ogive forebody and a cylindrical aftbody that inserts into the neck. The nose tip attaches into the forebody.

In further embodiments, the instrument package includes an instrument circuit board, an antenna, a harness buss, a control circuit board and a battery. The instrument board acquires measurement data. The antenna transmits measurement data via electromagnetic propagation. The bus passes measurement data through at least one wire through the disk. The control board acrivates the instrument board and the antenna. The battery supplies electrical power to the circuit boards.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1A is elevation and cross-sectional views of an exemplary instrumented round;

FIG. 1B is an exploded isometric view of components for the round;

FIG. 2 is an isometric assembly view of an instrument package;

FIG. 3 is an elevation view of a thermocouple board;

FIG. 4 is an exploded elevation view of an instrumentation housing;

FIG. 5 is an elevation cross-section view of a cartridge;

FIG. 6 is a set of isometric and cross-section views of a projectile;

FIG. 7 is an elevation assembly view of cartridge and projectile; and

FIG. 8 is an isometric view of an aft rim disk.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component. Communication and data exchange can be provided by various devices, such as a universal serial bus (USB).

The disclosure generally employs quantity units with the following abbreviations: length in meters (m) or inches (″), mass in grams (g), time in seconds(s), angles in degrees (°), force in newtons (N), temperature in kelvins (K) or degrees Fahrenheit (° F.), energy in joules (J) and frequencies in hertz (Hz). Supplemental measures can be derived from these, such as density in grams-per-cubic-centimeters (g/cm³), moment of inertia in gram-square-centimeters (kg-m²) and the like.

Exemplary embodiments provide an inert instrumented ammunition round configured for chambering in a gun barrel designed in the context described herein for a thirty millimeter (30 mm) bore. Artisans of ordinary skill will recognize that the ammunition size and related gun bore are exemplary and not limiting, such that design features described herein can be used for somewhat smaller rounds, or else much larger ones equipped for analogous instrumentation purposes.

The 30 mm wireless Instrumented Round is designed and intended to record temperatures of the projectile and cartridge of chambered round within a gun barrel. Heavy cadence of firing causes the gun barrel to rapidly rise in temperature, and the accumulated heat can cause the propellant in the cartridge to undergo Arrhenius self-heating, which if not dissipated can accelerate to induce thermal cook-off. Such hazards have resulted in naval fatalities, such as in 1967 aboard aircraft carrier USS Forrestal (CV59).

The exemplary instrumented round constitutes a telemetry device that enables an accurate technique to measure and report the live stream of the temperature of the chambered projectile. Data collected are used in a mathematical model to predict cook-off times so as to facilitate generating appropriate cooling periods between firing events to extend both the firing rate and the useful lifecycle of the GAU-23 gun.

The GAU-23 used aboard the AC130 aerial gunships has historically used a fixed energy method for calculating the gun temperatures as function of time and firing rate. Two primary conventional methods for obtaining physical cartridge temperatures exist:
1. instrument the gun breech by boring holes in the barrel at various stations and placing thermocouples as close to the internal surface as possible; and
2. employ a wired instrumented round, which requires removal of the gun feeder to manually insert the round without having the external wires tangle with the loading mechanism.

Wired rounds, in weapons such as the 105 mm howitzer, work well because the breech is manually operated, and the round is manually loaded. This enables wires and cables to be dealt with manually, and the conventional instrumented round immediately loaded into a hot gun for data collection. This technique is not tenable on an auto-loading weapon such as the 30 mm GAU-23.

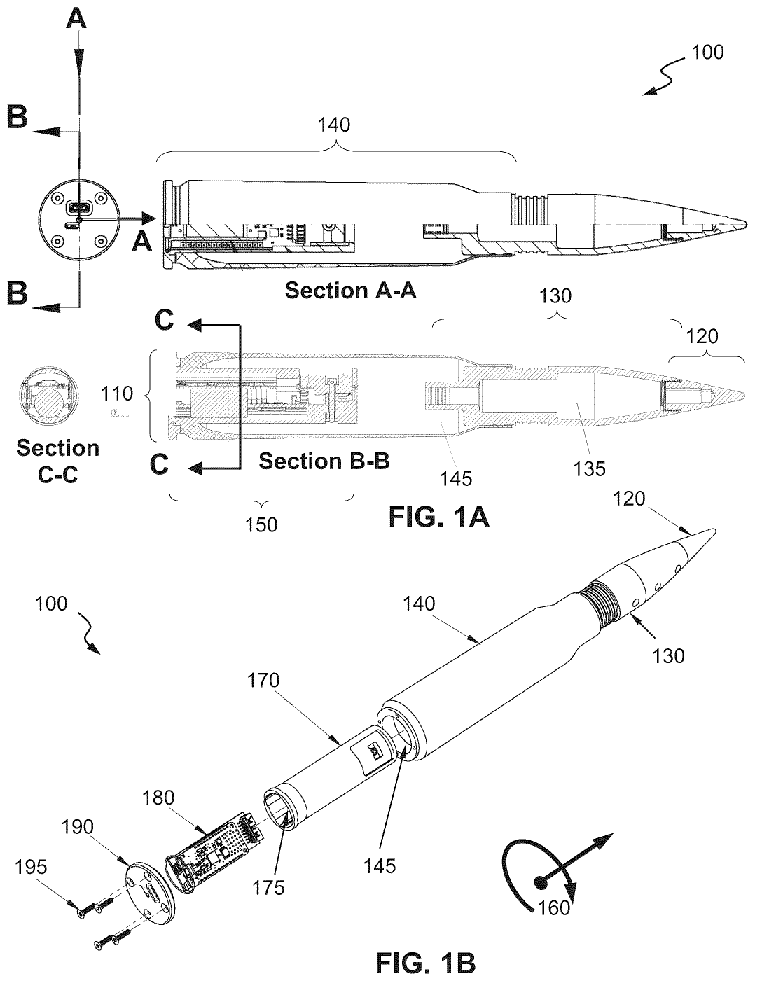

FIG. 1A shows elevation and cross-section views 100 of an exemplary inert instrumented ammunition round 110. Structural components include a conical nose tip 120, a partially hollow annular projectile 130 with a forebody interior cylindrical volume 135 and a hollow annular cartridge 140 with an aftbody interior cylindrical volume 145. An instrument package 150 is contained within the volume 145. These components are all chemically inert.

The GAU-23 constitutes an open breech gun. This means that between firings the gun bolt remains retracted in the open position. The exemplary instrumented round 110 enables air to pass through the barrel bore and facilitate cooling and gas venting. Given that the gun under thermal measurement is on an aircraft in flight, the cooling rate can be much greater than a land base counterpart and thus requiring quick action time in order to collect critical data before thermal dissipation occurs.

The upper elevation depiction represents Section A-A from above and front. The lower elevation depiction represents Section B-B along the axial length. A rear instrumentation portion represents Section C-C. The dimensions for this example for the round 110 would be 30 mm in diameter and 173 mm in length. Other sizes can be employed for testing alternative ammunition.

FIG. 1B shows an isometric exploded view 100 of the round's components. A compass rose 160 provides axial (forward) and angular (anti-clockwise) orientation for the round 110. A housing carriage 170 inserts into the cartridge's volume 145. The carriage 170 includes an opening 175 through which inserts modular self-contained instrument electronics 180. The combined electronics 180 and carriage 170 form the instrument package 150.

An aft dialectric rim disk 190 fastens to the cartridge 140 by screws 195 to secure the electronics 180 inside the carriage 170. The interior 145 is preferably filled with aerogel, a class of synthetic porous ultralight material used for thermal insulation and cushioning. Typical aerogels are composed from silica, alumina, chromia and tin oxide. The rim disk 190 is produced by fused deposition modeling (FDM) additive manufacture three dimensional (3D) printing from polyetherimide (PEI) amorphous thermoplastic. In particular, Ultem® from Curbell Plastics constitutes the tradename for this PEI composition. (See https://www.professionalplastics.com/professionalplastics/content/downloads/Ultem1000.pdf for additional information.)

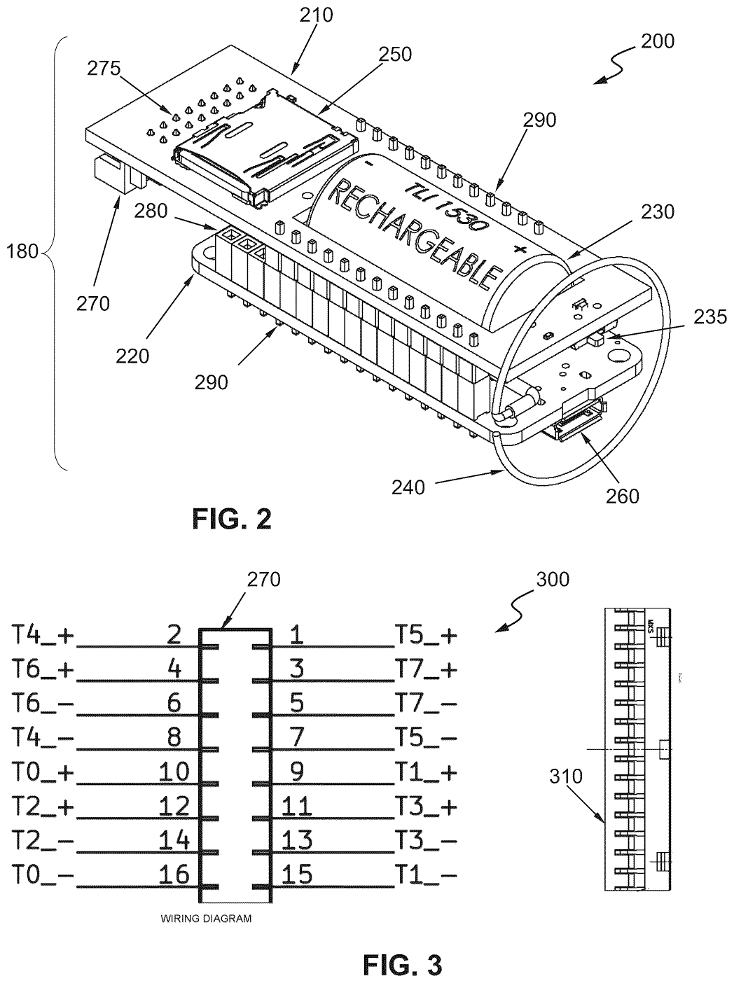

FIG. 2 shows elevation and plan views 200 of an internal electronics 180. Components include thermocouple (TC) board 210, an adapter instrument board 220, a rechargeable battery 230 with a switch 235, a circular loop antenna 240, an SD micro card 250, a micro-USB connector socket 260, a 16-pin connector 270 with connectors 275 on the board 210 that connect to a series of thermocouple blocks 280 through vias 290 that extend through both boards 210 and 220. The adapter board 220 constitutes a commercial off-the-shelf (COTS) component using an FR4 stackup.

The micro card 250 provides memory storage for measurement and calibration data. The socket 260 can be used for transferring electrical power, as well as serving as a microcontroller unit (MCU) on the board 220 for debugging as an input/output (I/O) programming port. The adapter board 220 can be programmed to shutdown during inactivity to reduce power consumption of the battery 230. For this example, the battery 230 constitutes a TLI-1530 lithium battery, 1.57″ in diameter from Tadiran. (See https: tadiranbatteries.de/wp-content/uploads/2021/05/TLI-1530.pdf for additional information.)

FIG. 3 shows a wiring diagram view 300 of a thermocouple connector 270. Each thermocouple (TC) is assigned to a corresponding pin 275, such as T5+ to pin one and T2− to pin fourteen, and so forth. The connector 270 on the board 220 includes a schematic representation 310 of the pinout for the thermocouple blocks 280.

FIG. 4 shows an exploded elevation view 400 of an instrument carriage 170 that contains the electronics 180. This includes a board carrier 410 and an accompanying plug 420. The carrier 410 and plug 420 are secured by a cap screw 430 and a washer 440. A pair of membranes 450 and a nut 460 are also installed in the carrier 410. The plug 420 and nut 460 each insert into corresponding cavities 470 and 480. The carrier 410 and plug 420 are composed of PEI.

FIG. 5 shows an elevation cross-section view 500 of a cartridge 140. A neck 510 receives the projectile 130. A frustum 520 transitions to an expanded propellant container 530 having an aft insertion cavity 540 for receiving the instrument package 150. A series of holes 550 spaced by radii 560 extend from the frustum 520 in the fore portion of the container 530.

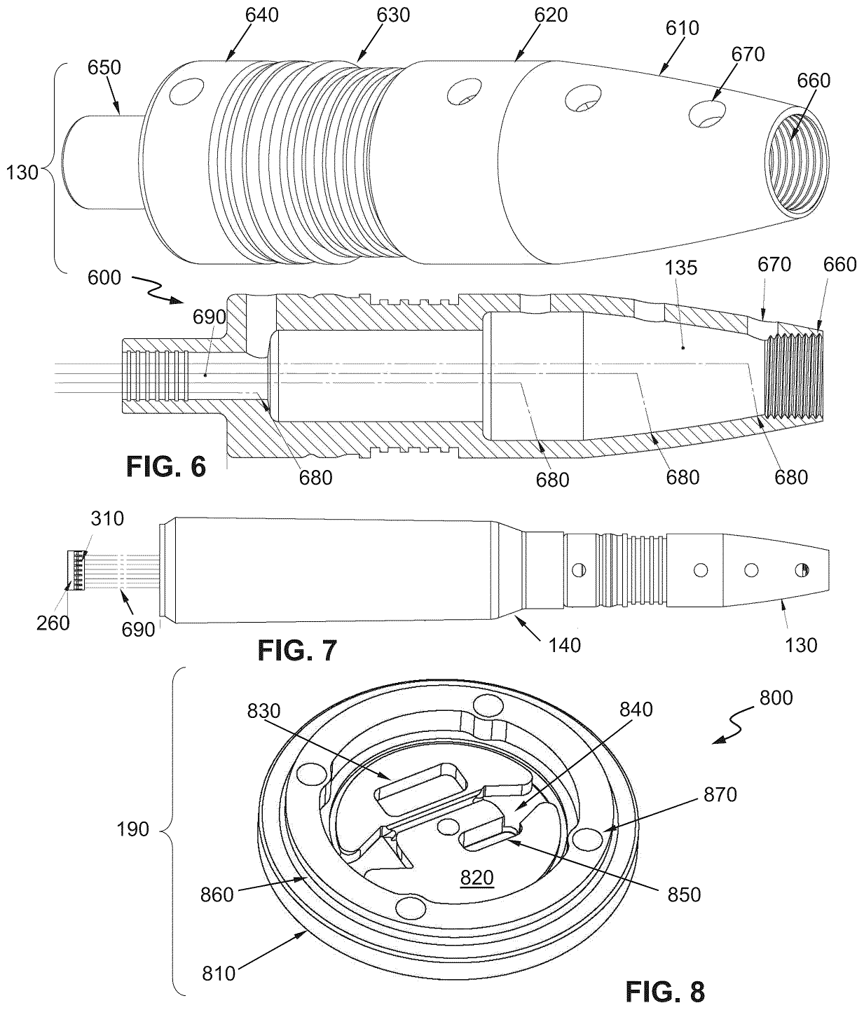

FIG. 6 show respective isometric and cross-section views 600 of a projectile 130. An ogive annulus 610 connects to a fore annulus 620. This connects to a knurl annulus 630, which connects to an aft annulus 640, and terminates at a tracer boom 650. The aft annulus 640 inserts into the cartridge's neck 510. The ogive annulus 610 includes female threads 660 into which the nose tip 120 attaches by screwing. A series of holes 670 (with four being shown, but not limiting) enables attachment of thermocouple junctions 680 with wires 690 connecting thereto that extend beyond the boom 650.

FIG. 7 shows an elevation view 700 of the projectile 130 and cartridge 140. The wires 690 are shown extending through the rim disk 190 and to the USB socket 260. The cartridge 140 and the projectile 130 are both composed of steel, as is the nose tip 120 also.

FIG. 8 shows an isometric view 800 of an aft rim disk 190, which is additively manufactured through FDM printing of amorphous Ultem® resin (either 1010 or 9085 versions) as a single component. This dielectric PEI facilitates production and has dielectric properties that facilitate electromagnetic communication via the antenna 240. The disk 190 includes an outer rim 810 that conforms to the cartridge 140, as well as a flat circular plate 820 with cutout windows 830, 840 and 850 for passing TC wires 690. The rim 810 also includes an annular mandrel 860 with holes 870 through which the screws 195 pass to secure the disk 190 to the cartridge 140. The antenna 240 fits into the mandrel 860

The wireless nature of the instrumented round 110 enables linkage at the end of the ammo belt fed to the gun for seamless chambering. No modification to the gun or the firing operations is required, and this vastly improves on the logistics of instrumenting the weapon system and shortens the time required to collect data at the end of a firing event.

The wireless instrumented round 110 includes a modified 30 mm cartridge assembly (view 100) with thermocouples 280 disposed throughout and an instrument package 150. The cartridge hollow space 145, usually used for high explosive, is instead repurposed to house several welded thermocouples 280 and their wires 690. These wires 690 then extend through the tracer boom 650 at the end of the projectile 130 into the cartridge 140, which is normally filled with propellant, but in the exemplary configuration instead houses several more TCs 280 in a circular pattern around the neck 510, the instrument package 150. The cartridge's void space 145 is filled with highly insulating aerogel.

The base of the cartridge 140, in early models, was designed to have an antenna 240 wrapped around the cartridge rim disk 190 in a machined slot with a threaded access cover in the base of the round 110. This configuration blocked radio signals when inserted fully into the GAU-23's chamber bore. Instead for the round 110, the base is machined off beyond the rim, and the rim disk 190 attaches in position via bolts 195, maintaining the dimensions of an existing 30 mm cartridge. This leaves the antenna 240 inside the radio frequency (RF) transparent rim disk 190, which resides external to the weapon chamber, significantly less restricted to conduct RF energy.

The electronics 180 inside of the round 110 includes an FDM printed carriage 170, the TC interface board 210, and the adapter board 220 for development equipped with a COTS-supplied LoRa® wireless microchip. Adafruit Feather MO with a 900 MHz radio constitutes an example. (See https://www.mouser.com/datasheet/2/737/adafruit-feather-m0-radio-with-lora-radio-module-1395898.pdf for more information.) The TC board 210 contains the circuitry to interface a single analog-to-digital converter (ADC) chip with 8× TC channels 280, detect motion, store data, and support an onboard rechargeable battery 230 controlled by a battery management power switch 235 with a status light emitting diode (LED).

The COTS adapter board 220 manages channel reading, data collection and storage, configuration, and communications with a base station. The board 220 also includes a basic circuit 250 for the charging and management of the onboard lithium battery 230 with a rear mounted universal serial bus (USB) connection socket 260. This socket 260 is used to charge the round 110 before and after test usage. When fully assembled, the board stack of the electronics 180 can be gently inserted into or removed from the carriage 170, which typically remains inside the round 110 and holds the combined TC connector 280 in position to the socket 260 with aerogel inside the 30 mm volume 145.

To configure and operate a single or multiple rounds, another COTS board 220 similar to that used in the round 110 connects to a computer over a USB connection socket 260. This “base station” re-uses all of the RF firmware as the board 220 on the instrumented round 110 has, but also provides a text user interface and data readout via terminal application of the operator's selection. The operator may employ this interface to configure, start, stop the round 110, and send/query calibration and identification (ID) settings.

The wireless instrumented round 110 provides advantages in auto-loading weapons such as the GAU-23 30 mm autocannon. Weapons that cannot normally permit wires or hand loading of munitions or test-rounds without serious changes to configuration or disassembly. The wireless round 110 by comparison, is designed and able to pass through the system as a “dud” un-fireable round, collecting time critical data immediately after the forgoing round has fired all while gracefully dealing with extreme temperatures found in a hot gun.

Further, while the round 110 does store configuration and data locally, the round 110 also transmits its status live to the base station for logging and monitoring. This live-data approach significantly lowers the risk of data collection loss remaining unnoticed. This approach further increases data and test safety by providing status of both the round and gun chamber thermal states during live testing. The gun case is modified to accept an RF transparent case rim which enables transmission of the wireless data.

For further in situ adaptability, the exemplary round 110 is designed to permit hot swapping of electronics packages. The electronics 180 may be field removed in a modular manner from the carriage 170 through the rear of the round 110 and replaced with a new assembly as necessary. The exemplary round 110 needs to perform while subjected to temperatures upwards of 400° F. for ten minutes or more while maintain internal electronic temperatures below 255° F. This is achieved by using aerogel insulation between the cartridge 130 and the instrument package 150. Live data transmission constitutes a challenge that has prevented prior wireless attempts from being viable.

The GAU-23 hot gun analysis team examined several possible options and other attempts at weapon instrumentation. Originally, the more basic “wired round” approach would have been used, with the acceptance of data loss from delay to field strip the receiver from the GAU-23 in situ. Although “electronically driven instrumented rounds” have existed in several forms, but three issues remained unsolved in those investigated:
Enable wireless operation from the closed-bolt loaded state.
Fit inside a dimensionally unmodified 30 mm cartridge 140.
Endure thermal conditions of a severe hot gun state.

Many instrumented rounds are designed to collect data after firing, and thus the issue of RF communications from inside a large metal assemblage is not a concern. The heat of moving through the air isn't much of a concern unless the velocities are very high and or long in duration. Lastly, many of the solutions we found were designed around much larger projectiles, such as the 5″ gun and various large bore weapons (>100 mm bore). Only two options remained: either employ the existing in-house wired round, or develop an alternative.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. An inert ammunition round for data collection in a gun bore, said round comprising:
a hollow annular cartridge defining an interior volume longitudinally bounded by a fore neck and an aft terminus;
an instrument package for disposal into said volume for data transmission;
a circular dielectric disk secured at said aft terminus;
an annular projectile having an ogive forebody and a cylindrical aftbody that inserts into said neck; and
a conical nose tip that attaches into said forebody.

2. The round according to claim 1, wherein the diameter of said cartridge is 30 mm.

3. The round according to claim 1, wherein said volume is filled with aerogel.

4. The round according to claim 1, wherein said disk is composed of thermoplastic polyetherimide resin.

5. The round according to claim 1, wherein said cartridge, projectile and nose tip are composed of steel.

6. The round according to claim 1, wherein said instrument package includes electronics contained in a carriage.

7. The round according to claim 6, wherein said electronics includes:
an instrument circuit board for acquiring measurement data;
an antenna for transmitting said measurement data via electromagnetic propagation;
a harness bus for passing said measurement data through at least one wire through said disk;
a control circuit board for activating said instrument circuit board and said antenna; and
a battery for supplying electrical power to said circuit boards.

8. The round according to claim 7, wherein at least one thermocouple attaches to an interior surface of said projectile for temperature measurement and connects to said instrument circuit board.
